(19) United States
(12) Patent Application Publication
(10) Pub. No.: US 2008/0199800 A1
(43) Pub. Date: Aug. 21, 2008

(54) RESIN-FILLED FERRITE CARRIER FOR ELECTROPHOTOGRAPHIC DEVELOPER AND ELECTROPHOTOGRAPHIC DEVELOPER USING THE FERRITE CARRIER

(75) Inventors: Hiromichi KOBAYASHI, Kashiwa-shi (JP); Takao SUGIURA, Kashiwa-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/033,384

(22) Filed: Feb. 19, 2008

(30) Foreign Application Priority Data
Feb. 20, 2007 (JP) 2007-038845

(51) Int. Cl. G03G 9/083

(52) U.S. Cl. 430/111.31

(57) ABSTRACT

A resin-filled ferrite carrier for an electrophotographic developer filled with a silicone resin in voids of a porous ferrite core material which continuously extend from a surface to a core interior, wherein the resin-filled ferrite carrier has an average particle size of 20 to 50 μm, and (Si/Fe)×100 as determined from X-ray fluorescence elemental analysis is 2.0 to 7.0, and the particle size and (Si/Fe)×100 are correlated, and wherein in the correlation relationship between [(Si/Fe)×100] and the particle size, a gradient (a) in a correlation equation thereof is −0.50≦a≦0.15.

### TECHNICAL FIELD

The present invention relates to a resin-filled ferrite carrier for an electrophotographic developer used in a two-component electrophotographic developer used in copiers, printers and the like, and an electrophotographic developer using this ferrite carrier. More specifically, the present invention relates to a resin-filled ferrite carrier for an electrophotographic developer having a lightened true density, a lengthened life, a high charging capability and which is stable, and an electrophotographic developer using this ferrite carrier.

### BACKGROUND ART

Electrophotographic developing methods develop by adhering toner particles in a developer to an electrostatic latent image which is formed on a photoreceptor. The developer used in such methods can be classified as either being a two-component developer composed of toner particles and carrier particles, or a one-component developer which only uses toner particles.

Among such developers, as the developing method using a two-component developer composed of toner particles and carrier particles, a cascade method or the like has long been employed. However, currently magnetic brush methods using a magnet roll have become mainstream.

In a two-component developer, carrier particles act as a carrying substance for imparting the desired charge to the toner particles and transporting the thus-imparted toner particles with a charge to the surface of the photoreceptor to form a toner image on the photoreceptor by stirring the carrier particles with the toner particles in a developing box which is filled with the developer. Carrier particles remaining on the developing roll which supports the magnets return back into the developing box from this developing roll, and are then mixed and stirred with new toner particles for reuse over a certain time period.

Unlike one-component developers, in two-component developers the carrier particles are mixed and stirred with the toner particles to charge the toner particles. The carrier particles also have a transporting function and are easily controlled when designing the developer. Therefore, two-component developers are suitable for full color developing apparatuses in which high image quality is demanded and for apparatuses performing high-speed printing in which the reliability and durability of image sustainability are demanded.

In two-component developers which are used in such a manner, the image properties, such as image density, fogging, white spots, gradation and resolution, need to exhibit a certain value from the initial stage. Furthermore, these properties must not change during printing and have to be stably maintained. To stably maintain these properties, it is necessary for the properties of the carrier particles in the two-component developer to be stable.

Conventionally, an iron powder carrier, such as iron powder covered with an oxide coating on its surface or iron powder coated with a resin on its surface, has been used for the carrier particles forming a two-component developer. These iron powder carriers have high magnetization as well as high conductance, and thus have the advantage that an image with good reproducibility of the solid portions can be easily obtained.

However, the true specific gravity of such an iron powder carrier is about 7.8, which is heavy, and its magnetization is too high. As a consequence, the toner constituent component tends to fuse to the surface of the iron powder carrier, so-called “toner spent”, from the stirring and mixing with the toner particles in the developing box. Due to the occurrence of toner spent, the effective carrier surface area decreases, whereby the frictional chargeability with the toner particles tends to deteriorate.

With a resin-coated iron powder carrier, the resin on the surface may peel away due to stress during use, causing charge to leak as a result of the high conductance, low breakdown voltage core material (iron powder) being exposed. The electrostatic latent image formed on the photoreceptor breaks down as a result of such charge leakage, thus causing brush strokes or the like to occur on the solid portions, which makes it difficult to obtain a uniform image. For these reasons, iron powder carriers, such as an oxide-coated iron powder or a resin-coated iron powder, are currently no longer used.

As described in Japanese Patent Laid-Open No. 59-48774, recently, instead of iron powder carriers, resin-coated ferrite carriers coated with a resin on their surface are often used which use a ferrite core material having a light true specific gravity of about 5.0 and a low magnetization, whereby developer life has become dramatically longer.

However, in recent years the workplace has become more networked, evolving from an era of single-function copiers to multifunction devices. In addition, the type of service provided has shifted from a system wherein a contracted repair worker carries out regular maintenance and replaces the developer and other parts to a maintenance-free system. Further, demands from the market for even longer developer life are becoming much greater.

Further, full color images are now standard in the workplace, so that there is an increasing demand for higher quality images. Toner particle size is also decreasing in order to obtain higher resolution.

In response to these demands, the carrier particle size is also shifting towards a smaller particle size having a higher specific surface area, as it is necessary for the desired charge to be quickly charged onto the toner. If the overall particle size distribution moves to a smaller particle size, the particles on the finer powder size, especially, are more likely to scatter or adhere to the photoreceptor, so-called “carrier adhesion”. As a result, critical image defects such as white out are more easily induced. Therefore, small particle size carriers must be controlled to have an even narrower particle size distribution width.

In view of these circumstances, many proposals have been made concerning magnetic powder-dispersed carriers in which fine, magnetic microparticles are dispersed in a resin to extend developer life by making the carrier particles lighter. See, for example, Japanese Patent Laid-Open No. 5-40367.

Such a magnetic powder-dispersed carrier can reduce true density by reducing the amount of magnetic microparticles, thus reducing the stress from stirring. As a result, chipping or peeling of the coating can be prevented, whereby stable image properties for a long period of time can be obtained.

However, because a binder resin covers the magnetic microparticles, the magnetic powder-dispersed carrier has a high carrier resistance. Thus, there is the drawback that it is difficult to obtain sufficient image density.

In addition, since the magnetic microparticles are hardened by the binder resin, the magnetic powder-dispersed carrier has also had the drawbacks that the magnetic microparticles detach due to stirring stress or from shocks in the developing apparatus, and that the carrier particles themselves split, possibly as a result of having inferior mechanical strength as compared with the conventionally-used iron powder carrier or a ferrite carrier. The detached magnetic microparticles or split carrier particles adhere to the photoreceptor, thereby becoming a factor in causing image defects.

Further, a magnetic powder-dispersed carrier has the drawback that since fine magnetic microparticles are used, remnant magnetization and coercive force increase, so that the fluidity of the developer deteriorates. Especially when a magnetic brush is formed on a magnet roll, the bristles of the magnetic brush stiffen due to the presence of remnant magnetization and coercive force, which makes it difficult to obtain high image quality. There is also the problem that even when the carrier leaves the magnet roll, because the carrier magnetic agglomerations do not come unloose and the carrier cannot be rapidly mixed with the supplied toner, the rise in the charge amount is poor, which causes image defects such as toner scattering and fogging.

In addition, while a magnetic powder-dispersed carrier can be produced by two methods, crushing or polymerization, the crushing method has a poor yield, and the polymerization method has a complicated production process. Thus, both methods have the problem of high costs.

A resin-filled carrier in which the voids in a porous carrier core material are filled with a resin has been proposed as a replacement for magnetic powder-dispersed carriers. For example, Japanese Patent Laid-Open No. 11-295933 and Japanese Patent Laid-Open No. 11-295935, describe a carrier which comprises cores or hard magnetic cores, a polymer contained in the pores of the cores, and a coating which covers the cores. These resin-filled carriers enable a carrier to be obtained having few shocks, a desired fluidity, a broad range of frictional charge values, a desired conductance and a volume average particle size that is within a certain range.

Japanese Patent Laid-Open No. 11-295933 describes that various suitable porous solid core carrier substances, such as a known porous core, may be used as the core material. Japanese Patent Laid-Open No. 11-295933 states that it is especially important that the carrier is porous and has the desired fluidity, and that soft magnetism, porosity as represented by BET surface area and volume average particle size are properties which need to be given attention.

However, as is described in the examples of Japanese Patent Laid-Open No. 11-295933, for a porosity of about 1,600 cm²/g in BET surface area, a sufficient reduction in the specific gravity is not achieved even by filling with a resin, and thus such a carrier cannot cope with the recent ever increasing demands for lengthened developer life.

Further, the sponge iron powder used in the examples of Japanese Patent Laid-Open No. 11-295933 cannot achieve a sufficient reduction in specific gravity even when filled with a resin, and thus the carrier is far from attaining the desired lengthened life.

Japanese Patent Laid-Open No. 11-295933 also describes that it is difficult to precisely control the specific gravity and mechanical strength of a carrier which has been filled with resin merely by controlling the porosity as represented by BET surface area.

The measurement principle of BET surface area is to measure the physical and chemical adsorption of a specific gas, which does not correlate with the porosity of the core material. In other words, it is typical for BET surface area to change depending on particle size, particle size distribution and nature of the surface material even for a core material that has hardly any pores. Thus, even if porosity is controlled using the BET surface area measured in the above-described manner, it cannot be said that the core material can be sufficiently filled with resin. If a large amount of resin is filled into a core material having a high BET surface area value but which is not porous, or into a core material which is not sufficiently porous, the resin which could not be filled remains by itself without closely adhering to the core material. In such a state, the left-over resin floats in the carrier, causing a large amount of agglomerates to form among the particles, whereby fluidity deteriorates. When agglomerates break apart during toner usage, charge properties fluctuate greatly, making it difficult to obtain stable properties.

Additionally, a resin-filled carrier having a three-dimensional laminated structure in which a resin layer and a ferrite layer are alternately present cannot be obtained just by controlling the BET surface area. The present inventors discovered that a resin-filled carrier having a plurality of three-dimensional laminated structures in which a resin layer and a ferrite layer are alternately present can be obtained by filling resin into the voids of a porous ferrite core material wherein the voids are continuous from the surface through to the core material interior. The term “three-dimensional laminated structure” as used here refers to, in a carrier particle cross section, a structure in which a plurality of resin layers and ferrite layers alternate with each other from one end to the other along a straight line (diameter) drawn passing through the center of the particle. The present inventors discovered that by forming such a three-dimensional laminated structure, due to the retention of a capacitor-type nature, the structure has excellent charging capability and stability, yet has a high strength as compared to a magnetic powder-dispersed carrier. As a result, the structure has the advantage of not splitting, deforming or melting from heat or shocks. In contrast, the resin-filled carrier described in Japanese Patent Laid-Open No. 11-295933 does not obtain these advantages.

Further, in Japanese Patent Laid-Open No. 11-295933, a porous core is used, and the total content of the resin filled in the cores and the resin which coats the surface of the cores is preferably about 0.5 to 10% by weight of the carrier. In the examples of Japanese Patent Laid-Open No. 11-295933, the greatest total content of the resins does not even reach 6% by weight of the carrier. With such a small amount of resin, the desired low specific gravity cannot be realized, meaning that a performance that is merely approximate to that of the conventionally used resin-coated carrier is obtained.

In addition, when a hard magnetic core such as that described in Japanese Patent Laid-Open No. 11-295935 is used, there is the drawback that the fluidity of the developer deteriorates due to the high remnant magnetization and coercive force. Especially when a magnetic brush is formed on a magnet roll, the bristles of the magnetic brush stiffen due to the presence of remnant magnetization and coercive force, which makes it difficult to obtain high image quality. There is also the problem that even when the carrier leaves the magnet roll, because the carrier magnetic agglomerations do not come unloose and the carrier cannot be rapidly mixed with the supplied toner, the rise in the charge amount is poor, which causes image defects such as toner scattering and fogging.

Japanese Patent Laid-Open No. 54-78137 describes a carrier for an electrostatic image developer in which the pores and recesses on the surface of magnetic particles, which are either porous having a bulk specific gravity that is smaller than that of a substantially non-porous substance, or which have a large surface roughness, are filled with a fine powder consisting of an electrical insulating resin. Japanese Patent Laid-Open No. 54-78137 describes that this carrier enables a developer to be obtained which has the advantages of a low toner accumulation on the carrier surface, stable powder properties and friction charge properties under varying temperature and humidity conditions and an image density that is constant and does not deteriorate over time.

However, when a fine powder is filled into the pores of porous or high-surface-roughness magnetic particles, if an iron powder such as that described in the examples of Japanese Patent Laid-Open No. 54-78137 is used, while the powder is comparatively easy to fill, it is difficult to fill such a fine powder into extremely fine voids as is the case with the voids of a ferrite core material.

Further, if an attempt is made to fill the fine powder by dispersing it in a solvent, as described above, it can be comparatively uniformly filled if the core material is an iron powder. However, if a ferrite core material is used, only the solvent seeps into the voids of the core material, and the dispersed fine powder remains on the core material surface. This has the drawback that the powder is easily detached if subjected to mechanical stress in the developing apparatus, which causes charge properties and resistance properties to dramatically vary.

Accordingly, not even the resin-filled carriers described in Japanese Patent Laid-Open Nos. 11-295933, 11-295935 or 54-78137 can satisfactorily ensure image density, nor can they adequately satisfy the demands for maintaining a high level of image quality over a long period of time.

Especially, while the resin-filled carriers described in Japanese Patent Laid-Open Nos. 11-295933, 11-295935 and 54-78137 fill a resin or a fine powder consisting of an electrical insulating resin, essentially the way in which this is carried out is to merely increase the amount of resin in a carrier having a surface of a conventionally-known core coated by a resin, and just a tiny amount of this seeps into the voids. Charging capability and stability are not at a satisfactory level.

Japanese Patent Laid-Open No. 2006-337579 proposes a resin-filled carrier wherein a resin is filled in a ferrite core material having a void fraction of 10 to 60%. In Japanese Patent Laid-Open No. 2006-337579, because the carrier is filled with a resin, it has a lighter true density, can achieve a longer life and has excellent fluidity. Further, depending on the selection of the resin which is filled, it is easy to control the amount of charge or the like, yet the carrier is stronger than a magnetic powder-dispersed carrier, so that there is no splitting, deforming or melting from heat or shocks. This filled carrier overcomes the problems of the resin-filled carriers described in the above Japanese Patent Laid-Open Nos. 11-295933, 11-295935 and 54-78137.

However, even for the resin-filled carrier described in Japanese Patent Laid-Open No. 2006-337579 there are cases where carrier adhesion and charge amount stability are harmed, which are factors in the inability to ensure image density or to maintain a high level of image quality when the carrier is used as electrophotographic developer along with a toner.

Thus, there is a need for a resin-filled carrier which prevents carrier adhesion or which has good charge amount stability, while maintaining the advantages of the above-described filled carriers.

### DISCLOSURE OF THE INVENTION

### Problems to be Solved by the Invention

Accordingly, it is an object of the present invention to provide a resin-filled ferrite carrier for an electrophotographic developer, which is used as an electrophotographic developer by mixing with a toner, which prevents carrier adhesion or which has good charge amount stability. It is a further object of the present invention to provide an electrophotographic developer using this ferrite carrier, which can ensure image density and maintain a high level of image quality.

### Means for Solving the Problems

As a result of extensive studies into resolving the above-described problems, the present inventors discovered that in order to prevent carrier adhesion or to have good charge stability, it is necessary to reduce variation among the particles in the amount of resin present in the surface vicinity of the resin-filled ferrite carrier, and determine the correlation between the average particle size of the resin-filled ferrite carrier and the amount of resin present on the surface to set the gradient of such correlation within a certain range. The present inventors further found that when this resin-filled ferrite carrier is used in an electrophotographic developer along with a toner, that image density can be sufficiently ensured and a high level of image quality can be maintained for a long period of time, thereby arriving at the present invention.

This shall now be described in more detail. While a resin-filled ferrite carrier can achieve a longer life by lowering the true specific gravity, because the true specific gravity is low, the magnetization of a particle is also small. This becomes a factor in inducing carrier adhesion. To reduce carrier adhesion, the following means can generally be thought of: a) increase magnetization by adjusting the ferrite composition or the production conditions; b) reduce the level of fine particles (make the particle size distribution narrower); and c) make resistance higher.

Although the above c) is a means for further lowering carrier adhesion after having implemented a) and b), there is the problem that if the resistance is made too high, it becomes difficult to obtain image density.

As a result of investigation into this matter, the present inventors discovered that for a resin-filled ferrite carrier, this problem can be resolved by changing the amount of resin present in the surface vicinity according to particle size.

It is especially important that the difference between the amount of resin consisting of fine particles present in the surface vicinity and the amount of resin having a large particle size present in the surface vicinity, which is the main cause for carrier adhesion, is small or that the amount of resin consisting of fine particles is greater than the amount of resin having a large particle size. When this is the case, the resistance of the small particle size resin is not that much lower than that of the large particle size resin. Further, since smaller particles have a higher resistance, when the amount of resin consisting of fine particles present in the surface vicinity is greater than the amount of resin having a large particle size, carrier adhesion is less likely to occur. However, this difference (difference in amount of resin according to particle size) is preferably not too large, as other problems can occur.

Specifically, if the amount of resin consisting of small particle size particles is increased too much, the carrier as a whole has too high a resistance, thus making it more difficult to obtain image density. In addition, the resistance of the small particle size particles becomes too high, whereby it becomes more difficult to alleviate the charge remaining in the carrier after the toner has been developed. As a result, carrier adhesion (so-called “carrier developing”) occurs. It is thus not preferable to increase the amount of resin consisting of small particle size particles too much. On the other hand, the amount of resin consisting of large particle size particles is preferably not too low, as this also becomes a factor for carrier adhesion.

The present invention provides a resin-filled ferrite carrier for an electrophotographic developer filled with a silicone resin in voids of a porous ferrite core material which continuously extend from a surface to a core interior, wherein the resin-filled ferrite carrier has an average particle size of 20 to 50 μm, and (Si/Fe)×100 as determined from X-ray fluorescence elemental analysis is 2.0 to 7.0, and the particle size and (Si/Fe)×100 are correlated, and wherein in the correlation relationship between [(Si/Fe)×100] and the particle size, a gradient (a) in a correlation equation thereof is −0.50≦a≦0.15.

The resin-filled ferrite carrier for an electrophotographic developer according to the present invention is preferably such that 6 to 30 parts by weight of the silicone resin are filled per 100 parts by weight of the porous ferrite core material.

In the resin-filled ferrite carrier for an electrophotographic developer according the present invention, a composition of the porous ferrite core material preferably comprises at least one selected from the group consisting of Mn, Mg, Li, Ca, Sr, Cu and Zn.

The resin-filled ferrite carrier for an electrophotographic developer according to the present invention preferably has a saturated magnetization of 30 to 80 Am²/kg, a true density of 2.5 to 4.5 g/cm³, an apparent density of 1.0 to 2.2 g/cm³, and 5% or less by volume of particles having a diameter of less than 24 μm.

The present invention also provides an electrophotographic developer comprising the above-described resin-filled ferrite carrier for an electrophotographic developer and a toner.

### ADVANTAGE OF THE INVENTION

Since the resin-filled ferrite carrier for an electrophotographic developer according to the present invention is a resin-filled ferrite carrier, true density is lighter, a longer life can be achieved, fluidity is excellent and control of charge amount and the like can be easily carried out. Further, the resin-filled ferrite carrier is stronger than a magnetic powder-dispersed carrier, and yet does not split, deform or melt from heat or shocks. In addition, by reducing the variation in the amount of resin among the particles present in the surface vicinity, and determining the correlation between the average particle size of the resin-filled ferrite carrier and the amount of resin present on the surface to set the gradient of such correlation within a certain range, carrier adhesion can be prevented and good charge amount stability can be obtained. Further, an electrophotographic developer using this resin-filled ferrite carrier can ensure sufficient image density and maintain a high level of image quality for a long period of time.

### BEST MODE FOR CARRYING OUT THE INVENTION

Preferred embodiments for carrying out the present invention will now be described.

### <Resin-filled Ferrite Carrier for an Electrophotographic Developer According to the Present Invention>

In the resin-filled ferrite carrier for an electrophotographic developer according to the present invention, a silicone resin is filled in voids of a porous ferrite core material which continuously extend from the surface to the core interior. Such a silicone resin-filled ferrite carrier has a lighter true density, can achieve a longer life and has excellent fluidity. In addition, control of charge amount and the like can be easily carried out. Further, this silicone resin-filled ferrite carrier is stronger than a magnetic powder-dispersed carrier, and yet does not split, deform or melt from heat or shock.

The resin-filled ferrite carrier for an electrophotographic developer according to the present invention has an average particle size of 20 to 50 μm. Within this range, carrier adhesion can be prevented and good image quality can be obtained. If the average particle size is less than 20 μm, carrier adhesion occurs more easily, and thus is not preferable. If the average particle size is more than 50 μm, image quality tends to deteriorate, and thus is not preferable.

In the resin-filled ferrite carrier for an electrophotographic developer according to the present invention, (Si/Fe)×100 as determined from X-ray fluorescence elemental analysis is 2.0 to 7.0. The (Si/Fe)×100 as determined from X-ray fluorescence elemental analysis represents the amount of silicone resin present in the surface vicinity of the resin-filled ferrite carrier. If the above value is less than 2.0, the amount of resin present in the surface vicinity is too low, which is a factor in carrier adhesion occurrence, and charge performance deteriorates, and thus is not preferable. If the above value is more than 7.0, the amount of resin present in the surface vicinity is too large, whereby it becomes more difficult to alleviate the charge remaining in the carrier after the toner has been developed. As a result, carrier adhesion (so-called “carrier developing”) occurs, and thus the value preferably does not exceed 7.0. Further, the phenomenon wherein charge is accumulated over time (charge-up) is marked, which is a factor in image density reduction and image quality deterioration, and for this reason as well the value preferably does not exceed 7.0.

In the resin-filled ferrite carrier for an electrophotographic developer according to the present invention, particle size and (Si/Fe)×100 are correlated, wherein the gradient (a) in this correlation equation is −0.50≦a≦0.15, preferably −0.30≦a≦0.12 and especially preferably −0.25≦a≦0.10. If the gradient (a) is more than 0.15, the amount of resin consisting of small particle size particles present in the surface vicinity is less than that of large particle size particles, whereby carrier adhesion occurs. Thus, the gradient (a) is preferably not more than 0.15. However, the gradient (a) is preferably not less than −0.50, as other problems occur. Specifically, if the amount of resin consisting of small particle size particles is increased too much, the carrier as a whole has too high a resistance, thus making it more difficult to obtain image density. In addition, the resistance of the small particle size particles becomes too high, whereby it becomes more difficult to alleviate the charge remaining in the carrier after the toner has been developed. As a result, carrier adhesion (so-called “carrier developing”) occurs. It is thus not preferable to increase the amount of resin consisting of small particle size particles too much. On the other hand, the amount of resin consisting of large particle size particles is preferably not too low, as this also becomes a factor for carrier adhesion.

The resin-filled ferrite carrier for an electrophotographic developer according to the present invention is preferably such that 6 to 30 parts by weight of the silicone resin are filled per 100 parts by weight of porous ferrite core material. If the filled amount of the silicone resin is less than 6 parts by weight, it becomes more difficult to achieve a lower specific gravity of the carrier, and it is difficult to set the value for (Si/Fe)×100 in the desired range. If the filled amount of the silicone resin is more than 30 parts by weight, while a lower specific gravity of the carrier can be achieved, the carrier resistance is too high, which makes it more difficult to obtain image density. Thus, the filled amount of the silicone resin is preferably not more than 30 parts by weight.

The core material composition of the resin-filled ferrite carrier for an electrophotographic developer according to the present invention preferably comprises at least one selected from the group consisting of Mn, Mg, Li, Ca, Sr, Cu and Zn. Considering the recent trend towards reducing environmental burden, such as restrictions on waste products, it is preferable for the heavy metals Cu, Zn and Ni to be contained in an amount which does not exceed the scope of unavoidable impurities (accompanying impurities).

The resin-filled ferrite carrier for an electrophotographic developer according to the present invention preferably has a saturated magnetization of 30 to 80 Am²/kg, and more preferably 50 to 70 Am²/kg. If the saturated magnetization is less than 30 Am²/kg, it is easier for carrier adhesion to be induced. If the saturated magnetization is more than 80 Am²/kg, the bristles of the magnetic brush stiffen, which makes it difficult to obtain high image quality, and is thus not preferable.

The resin-filled ferrite carrier for an electrophotographic developer according to the present invention preferably has a true density of 2.5 to 4.5 g/cm³, more preferably 2.8 to 4.0 g/cm³, and most preferably 3.0 to 4.0 g/cm³. If the true density is less than 2.5 g/cm³, the true density of the carrier is too low and fluidity deteriorates, whereby charging speed is reduced and the magnetization per particle decreases too much, which is a cause in carrier adhesion. If the true density is more than 4.5 g/cm³, the true density is too high, so that a longer life cannot be achieved because of stress during use.

The resin-filled ferrite carrier for an electrophotographic developer according to the present invention preferably has an apparent density of 1.0 to 2.2 g/cm³. If the apparent density is less than 1.0 g/cm³, the shape is poor and protruding portions tend to increase. These portions are weak against mechanical stress and are brittle, thereby lowering strength, whereby the carrier tends to break. If the apparent density is more than 2.2 g/cm³, it is difficult to achieve a longer life.

The resin-filled ferrite carrier for an electrophotographic developer according to the present invention preferably has a volume of particles which are less than 24 μm of 5% or less. If the volume of particles less than 24 μm is more than 5%, carrier adhesion tends to be induced.

Examples of the silicone resin used in the resin-filled ferrite carrier for an electrophotographic developer according to the present invention include an unmodified straight silicone resin and a modified silicone resin modified by an acrylic resin, polyester resin, epoxy resin, polyamide resin, polyamideimide resin, alkyd resin, urethane resin, fluororesin or the like.

A conductive agent can be added into the silicone resin to be filled for the purpose of controlling the resistance, charge amount and charging rate of ferrite carrier. If too much of the conductive agent is added, a sudden charge leak can occur because of the low resistance of the conductive agent itself. For this reason, the addition amount may be 0.25 to 20.0% by weight based on the solid content of the filling resin, preferably 0.5 to 15.0% by weight and especially preferably 1.0 to 10.0% by weight. Examples of the conductive agent include conductive carbon, oxides such as titanium oxide or tin oxide, and various organic conductive agents.

In the above-described resin, a charge control agent can be contained. Examples of the charge control agent include various charge control agents generally used for toners and various silane coupling agents. This is because, although the charging capability is sometimes reduced if a large amount of resin is filled, it can be controlled by adding the charge control agent or the silane coupling agent. The charge control agents and coupling agents which may be used are not especially limited. Preferable examples of the charge control agent include a nigrosin dye, quaternary ammonium salt, organic metal complex and metal-containing monoazo dye. Preferable examples of the silane coupling agent include an aminosilane coupling agent and fluorinated silane coupling agent.

### <Measurement Method>

The measurement method for the respective physical properties of the resin-filled ferrite carrier according to the present invention will be described below.

### (Average Particle Size)

The average particle size was measured using a Microtrac Particle Size Analyzer (Model: 9320-X100), manufactured by Nikkiso Co., Ltd. Using water for the dispersing solvent, the test samples were directly charged into the apparatus without using a dispersant or particularly carrying out dispersion with an ultrasonic homogenizer.

### (X-ray Fluorescence Elemental Analysis)

One example of a method for measuring the amount of resin present in the carrier surface vicinity is to determine using an X-ray fluorescence elemental analyzer. X-ray fluorescence elemental analyzers are known to be effective in determining the amount of elements which are present several μm from the surface. Used as the measuring apparatus was a “ZSX 100s” manufactured by Rigaku Corporation. About 5 g of a sample was placed in a powder sample vessel for vacuum (RS640), which was then attached to the sample folder. The amounts of Si and Fe were then determined using the above apparatus. The measurement conditions for Si were that an Si—Kα line was taken as the measuring line, tube voltage was 50 kV, tube current was 50 mA, PET was used for the analyzing crystal and a PC (proportional counter) was used as the detector. The measurement conditions for Fe were that an Fe—Kα line was taken as the measuring line, tube voltage was 50 kV, tube current was 50 mA, LiF was used for the analyzing crystal and an SC (scintillation counter) was used as the detector.

Using each of the obtained X-ray fluorescence intensities, the intensity ratio (Si intensity/Fe intensity×100) was calculated.

### (Method for Deriving the Relationship Between Particle Size and the Results of X-ray Fluorescence Analysis)

Next, the method for evaluating the differences in Si/Fe values according to particle size will be described.

The carrier sample was placed on a shaking-type particle size distribution measuring machine which used a mesh. Here, the used mesh can be appropriately selected according to the average particle size of the carrier. However, to derive the relationship (correlation equation) between particle size and the Si/Fe×100 value, it is necessary to use at least two meshes which have different apertures. For example, for a carrier with an average particle size of about 40 μm, a 330 mesh and a 400 mesh may be used. If the carrier is classified using these meshes, the particles can be divided into three groups; particles that remained on the 330 mesh, particles which passed through the 330 mesh but remained on the 400 mesh, and particles which passed through the 400 mesh.

If the particles are small, for example having an average particle size of 20 μm, classification in the manner described above with a mesh is difficult. In such cases, classification can be carried out by using an air classifier, and varying the conditions such as rotation speed of the air classifier.

The average particle size of the classified carrier particles is measured and X-ray fluorescence elemental analysis is carried out. The obtained results are standardized based on the average particle size of the carried particles prior to classification and the Si/Fe×100 value both being set as 1. A graph was drawn with the standardized volume average particle size (volume average particle size after classification/volume average particle size prior to classification) on the horizontal axis and the standardized Si/Fe×100 value (Si/Fe×100 value after classification/Si/Fe×100 value prior to classification) on the vertical axis, to calculate the correlation equation and the gradient (a) of the correlation equation.

### (Magnetic Properties)

Saturated magnetization was measured using an integral-type B-H tracer BHU-60 (manufactured by Riken Denshi Co., Ltd.). An H coil for measuring magnetic field and a 4 πI coil for measuring magnetization were placed in between electromagnets. In this case, the sample was put in the 4 πI coil. The outputs of the H coil and the 4 πI coil when the magnetic field H was changed by changing the current of the electromagnets were each integrated; and with the H output as the X-axis and the 4 πI coil output as the Y-axis, a hysteresis loop was drawn on recording paper. The measuring conditions were a sample filling quantity of about 1 g, the sample filling cell had an inner diameter of 7 mm±0.02 mm and a height of 10 mm±0.1, and the 4 πI coil had a winding number of 30.

### (True Density)

The true density of the carrier particles was measured according to JIS R9301-2-1 by using a picnometer. Here, methanol was used as the solvent, and the measurement was carried out at a temperature of 25° C.

### (Apparent Density)

The apparent density was measured according to JIS Z2504 (Apparent density test method for metal powders).

### (Carrier Adhesion)

Carrier adhesion was evaluated by the following method. A magnet roll provided with magnets (magnetic flux density of 0.1 T) having a total of 8 poles alternating between N and S poles was arranged on the inner side of a cylindrical aluminum pipe (hereinafter “sleeve”) having a diameter of 31 mm and a length of 76 mm. A cylindrical electrode was arranged around the circumference of the sleeve with a gap of 2.5 mm between the electrode and the sleeve.

One gram of a developer was evenly adhered onto the sleeve. Then, with the outer side of the aluminum pipe fixed, a direct voltage of 2,000 V was induced for 90 seconds between the outer side electrode and the sleeve while the inner side magnet roll was rotated at 100 rpm, whereby toner was transferred to the outer side electrode.

Once 90 seconds had passed, the induced voltage was cut, and the magnet roll rotation was stopped. The outer side electrode was then removed, and the number of carrier particles that had adhered to the transferred toner was counted.

Here, the following evaluations were made according to the number of adhered carrier particles.

E: No adhered carrier particles

G: The number of adhered carrier particles was 1 to 3

M: The number of adhered carrier particles was 4 to 7

P: The number of adhered carrier particles was 8 or more

### (Charge Properties)

The charge amount was measured using a mixture of carrier and toner by a suction type charge measurement device (Eppingq/m-meter, manufactured by PES-Laboratorium). As the toner, a commercially available negative toner used in full-color printers (cyan toner for DocuPrint C3530, manufactured by Fuji Xerox Co., Ltd.) was used, and the toner concentration was adjusted to 5% by weight. The adjusted developer was charged into a 50 cc glass bottle and then stirred at a speed of 100 rpm.

The initial charge amount was set at the charge amount 5 minutes after of stirring with the toner. The saturated charge amount was set at the charge amount after 30 minutes of stirring. The smaller the difference between the initial charge amount and the saturated charge amount, the higher the charging speed is. In practice, this indicates rapid mixing with the supplied toner.

Further, the charge amount after 10 minutes of stirring was set as the charge amount after use. This is to confirm weather the charge amount varies as a result of long-term stirring stress. The closer this value is to the initial charge amount and the saturated charge amount, the more stable the charge properties are.

### <Method for Producing the Resin-Filled Ferrite Carrier for an Electrophotographic Developer According to the Present Invention>

The method for producing the resin-filled ferrite carrier for an electrophotographic developer according to the present invention will now be described.

To produce the resin-filled ferrite carrier for an electrophotographic developer according to the present invention, the raw materials are appropriately weighed, and then the resultant mixture is crushed and mixed by a ball mill, vibration mill or the like for 0.5 hours or more, and preferably for 1 to 20 hours. The resultant crushed material is pelletized using a pressure molding machine or the like, and calcined at a temperature of 700 to 1,200° C. This may also be carried out without using a pressure molding machine, by after the crushing adding water to form a slurry, and then granulating using a spray drier. The calcined material is further crushed by a ball mill, vibration mill or the like, and then charged with water, and optionally with a dispersant, a binder or the like to adjust viscosity. The resultant solution is granulated, and held at a temperature of 1,000 to 1,500° C. for 1 to 24 hours while the oxygen concentration is controlled to carry out sintering. In the case of crushing after calcination, the calcined material may be charged with water and crushed by a wet ball mill, wet vibration mill or the like.

The above crushing machine such as the ball mill or vibration mill is not especially limited, but, for uniformly and effectively dispersing the raw materials, preferably uses fine beads having a particle size of 1 mm or less as the media to be used. By adjusting the size, composition and crushing time of the used beads, the crushing degree can be controlled.

The resultant sintered material is crushed and classified. The particles are adjusted to a desired size using a conventionally-known classification method, such as air classification, mesh filtration and precipitation.

Thereafter, the electric resistance can be optionally adjusted by heating the surface at a low temperature to carry out an oxide film treatment. The oxide film treatment may be conducted using a common furnace such as a rotary electric furnace or batch-type electric furnace, and the heat-treatment may be carried out, for example, at 300 to 700° C. The thickness of the oxide film formed by this treatment is preferably 0.1 nm to 5 μm. If it is less than 0.1 nm, the effect of the oxide film is small. If it is more than 5 μm, the magnetization may decrease, and the resistance may become too high, which makes it difficult to obtain the desired properties. Reduction may optionally be carried out before the oxide film treatment.

Various methods may be used for filling the silicone resin into the resultant resin-filled ferrite carrier for an electrophotographic developer. Examples thereof include a dry method, spray-dry method using a fluidized bed, rotary-dry method, and liquid immersion-dry method using a universal stirrer. The method may be suitably selected from among these methods depending on the core material and resin to be used.

Here, to efficiently and effectively fill the silicone resin into the voids of the core material, the resin solution to be filled preferably has a low viscosity. If the viscosity is too high, it is difficult to fill the resin into the voids present inside the particles.

In cases where the viscosity is high, the solution may be used by diluting with various solvents. Diluting with a solvent allows the viscosity of the resin solution to be reduced, which makes it easier for the resin to be filled into the voids inside the particles.

The temperature when filling the resin must be precisely controlled. If the filling is carried out at a temperature higher than the temperature when the curing of the silicone resin started, the resin in the particle surface vicinity is cured, which may make it impossible to fill as far as the voids inside the particles. Further, it is preferable to carry out the filling at a temperature lower than the temperature at which the solvent volatizes. If the volatilization rate of the solvent is fast because of a high temperature, the viscosity of the resin solution during filling increases, which may make it impossible to fill as far as the voids inside the particles.

After the silicone resin has been filled, the heated and filled resin may optionally be adhered to the core material by various techniques. The heating may be performed using external heating or internal heating, and may use, for example, a fixed-type or flow-type electric furnace, rotary electric furnace or burner furnace. The heating may even be performed by baking using microwaves. Although the temperature depends on the resin to be filled, by increasing the temperature to the point where sufficient curing proceeds, a resin-filled ferrite carrier which is strong against shocks can be obtained.

A conventionally-known method may be used to further coat a resin onto the above-described ferrite carrier already filled with a resin. Examples of such coating methods include brush coating, dry method, spray-dry method using a fluidized bed, rotary-dry method and liquid immersion-dry method using a universal stirrer. To improve the coating efficiency, a method using a fluidized bed is preferable. The coated resin is not especially limited. Examples include a fluororesin, acrylic resin, epoxy resin, polyamide resin, polyamideimide resin, polyester resin, unsaturated polyester resin, urea resin, melamine resin, alkyd resin, phenol resin, fluoroacrylic resin, acryl-styrene resin, silicone resin, and a modified silicone resin modified by an acrylic resin, polyester resin, epoxy resin, polyamide resin, polyamideimide resin, alkyd resin, urethane resin, fluororesin or the like. Taking into consideration detachment of the resin due to mechanical stress during use, a thermosetting resin is preferably used. Specific examples of the thermosetting resin include an epoxy resin, phenol resin, silicone resin, unsaturated polyester resin, urea resin, melamine resin, alkyd resin, and a resin containing these.

After the ferrite carrier already filled with a resin has been coated with a resin, baking may be carried out by either external heating or internal heating. The baking can be carried out using, for example, a fixed-type or flow-type electric furnace, rotary electric furnace, burner furnace, or even by using microwaves. In the case of using a UV-curable resin, a UV heater is used. Although the baking temperature depends on the resin which is used, the temperature must be equal to or higher than the melting point or the glass transition point. For a thermosetting resin or a condensation-crosslinking resin, the temperature must be increased to a point where sufficient curing proceeds.

Examples of the method for controlling the amount of resin (Si/Fe×100) present in the surface vicinity according to particle size, which is a characteristic of the present invention, include the following.

The most simple method is to divide the particle size distributions of the core material which will serve as the basis for the ultimately-desired carrier particles into a plurality of distributions using a sieve or an air classifier. Once filled with differing amounts of resin, particles which have been divided up in this manner can be mixed to obtain carrier particles.

Another method is to subject carrier particles which have finished being filled to spray coating using a fluidized bed type coating apparatus. By coating a resin with a fluidized bed coater by spraying, each particle is coated with resin approximately the same number of times. Here, if the particle size is different, the surface area per particle will be different, so that the amount of resin present in the surface vicinity can be intentionally varied according to particle size.

Further, by combining the above-described two methods, the amount of resin present in the surface vicinity can be precisely controlled to a desired amount.

If a filling apparatus equipped with a stirrer is used, the amount of resin present in the surface vicinity according to particle size differs depending on whether the apparatus interior had a reduced pressure or whether it had a normal pressure or was in a pressurized state. Although the reason for this is not certain, if the filling apparatus is used in a reduced pressure state, the amount of resin present in the surface vicinity tends to decrease with a smaller particle size.

In addition, the amount of resin present in the surface vicinity according to particle size can be varied by appropriately adjusting the resin viscosity, drying rate and curing rate, or by combining solvents having different volatilization rates.

Specifically, the amount of resin present in the surface vicinity tends to increase with a higher resin viscosity, with a faster drying rate, curing rate and solvent volatilization rate, and with a smaller particle size.

The present invention will now be explained in more detail based on the following examples.

### EXAMPLE 1

Raw materials were weighed out in a ratio of 35 mol % of MnO, 14.5 mol % of MgO, 50 mol % of Fe₂O₃ and 0.5 mol % of SrO. The resultant mixture was crushed for 5 hours by a wet media mill to obtain a slurry. This slurry was dried by a spray dryer to obtain spherical particles. To adjust the void fraction which is formed, manganese carbonate was used for the MnO raw material and magnesium hydroxide was used for the MgO raw material. The particles were adjusted for particle size, and then heated for 2 hours at 950° C. to carry out calcination. Subsequently, to obtain an appropriate fluidity while increasing the void fraction, the particles were crushed for 1 hour by a wet ball mill using stainless steel beads ⅛ inch in diameter, and then crushed for a further 4 hours using stainless steel beads 1/16 inch in diameter. The resultant slurry was charged with an appropriate amount of dispersant. The slurry was also charged with 2% by weight of PVA based on solid content as a binder to ensure the strength of the particles to be granulated and to adjust the void fraction. The slurry was then granulated and dried by a spray drier, and the resultant granules were held at a temperature of 1,100° C. at an oxygen concentration of 0 vol % for 4 hours in an electric furnace to carry out sintering. Then, the sintered material was crushed and further classified for particle size adjustment. Low magnetic particles were then separated off by magnetic separation to obtain a core material for the ferrite particles. The volume average particle size of the ferrite core material was 37.2 μm.

Next, the obtained ferrite particles were separated using an air classifier into three groups having differing average particle sizes. Specifically, by changing the rotation speed of the air classifier rotor, the particles were classified into groups having an average particle size of 26.2 μm, 38.8 μm and 47.6 μm.

Next, the following three resin solutions were prepared.

### (Resin Solution 1)

A condensation-crosslinking methyl-based silicone resin (Trade name: SR-2411; manufactured by Dow Corning Toray Co., Ltd.) was prepared having a solid content of 20% by weight. Then, 925 parts by weight of this silicone resin (185 parts by weight in terms of solid content), 18.5 parts by weight of γ-aminopropyltriethoxysilane and 500 parts by weight of toluene were mixed together.

### (Resin Solution 2)

Mixing was carried out in the same manner as for Resin Solution 1, except that the 925 parts by weight of the silicone resin of was changed to 950 parts by weight, and the 18.5 parts by weight of y-aminopropyltriethoxysilane was changed to 19 parts by weight.

### (Resin Solution 3)

Mixing was carried out in the same manner as for Resin Solution 1, except that the 925 parts by weight of the silicone resin of was changed to 975 parts by weight, and the 18.5 parts by weight of y-aminopropyltriethoxysilane was changed to 19.5 parts by weight.

The obtained Resin Solution 1 and 1,000 parts by weight of the above-described ferrite particles having an average particle size of 47.6 μm, the obtained Resin Solution 2 and 1,000 parts by weight of the above-described ferrite particles having an average particle size of 38.8 μm and the obtained Resin Solution 3 and 1,000 parts by weight of the above-described ferrite particles having an average particle size of 26.2 μm, were each separately charged into a stirring/mixing vessel, and the resultant mixtures were then stirred at 50° C. under reduced pressure. The resin solutions were filled while the toluene was volatilized off.

The temperature was subsequently increased to 200° C., and the mixtures were stirred for 2 hours to cure the resin. Ferrite particles in which the resin had been filled and cured were taken out, and particle agglomerates were broken up using a vibrating sieve with 150 M apertures. Using a magnetic separator, non-magnetic matter was removed. Then, again using the magnetic separator, coarse particles were removed to obtain resin-filled ferrite particles filled with resins using different resin solutions and which had a different particle size.

These particles were mixed to obtain a resin-filled ferrite carrier. The volume average particle size of the obtained carrier was measured to be 40.7 μm. Other carrier properties and evaluation results are shown in Tables 1 and 2.

In addition, the volume average particle size of the carriers obtained in the following examples and comparative examples, and other carrier properties and evaluation results are also shown in Tables 1 and 2.

### EXAMPLE 2

The same ferrite core material as in Example 1 was produced. This core material was not subjected to air classification, and was used as the ferrite core material as is.

Using the same resin as that used in Example 1, 970 parts by weight of resin, 19.4 parts by weight of γ-aminopropyltriethoxysilane and 500 parts by weight of toluene were mixed together. Other than this, the mixing was carried out in the same manner.

A stirring/mixing vessel was charged with 1,000 parts by weight of the above-described ferrite core material and ⅓ of the above-described resin solution. The resultant mixture was stirred at 50° C. under normal pressure, and the resin was filled while the toluene was volatilized off.

After confirming that the toluene was almost entirely volatilized, the mixture was stirred while a further ⅓ of the resin solution was added dropwise at a rate of 20 g/min, and the toluene was volatilized off. Once the dropping of the resin solution was finished, the mixture was stirred for 3 minutes to thoroughly dry. The remaining ⅓ of the resin solution was then added dropwise and stirred in the same manner. The resin solution was filled while the toluene was volatilized off.

The temperature was subsequently increased to 200° C., and the mixture was stirred for 2 hours to cure the resin. Ferrite particles in which the resin had been filled and cured were taken out, and particle agglomerates were broken up using a vibrating sieve with 150 M apertures. Using a magnetic separator, non-magnetic matter was removed. Then, again using the magnetic separator, coarse particles were removed, to obtain resin-filled ferrite particles.

### EXAMPLE 3

The same ferrite core material as in Example 1 was produced. This core material was not subjected to air classification, and was used as the ferrite core material as is.

Using the same resin as that used in Example 1, 850 parts by weight of resin and 17 parts by weight of γ-aminopropyltriethoxysilane only were mixed together. The resin solution was prepared without mixing with toluene.

The mixture was stirred while 1,000 parts by weight of the above-described ferrite core material and the resin solution were added dropwise at a rate of 10 g/min. Once the dropping of the resin solution was finished, the mixture was stirred for 30 minutes to thoroughly dry.

The temperature was subsequently increased to 220° C., and the mixture was stirred for 2 hours to cure the resin. Ferrite particles in which the resin had been filled and cured were taken out, and particle agglomerates were broken up using a vibrating sieve with 150 M apertures. Using a magnetic separator, non-magnetic matter was removed. Then, again using the magnetic separator, coarse particles were removed, to obtain resin-filled ferrite particles.

### EXAMPLE 4

Using the same resin as that used in Example 1, 115 parts by weight of resin, 2.3 parts by weight of γ-aminopropyltriethoxysilane and 100 parts by weight of toluene were mixed together to prepare a resin solution.

A fluidized bed coater equipped with two flow nozzles was charged with 1,000 parts by weight of the carrier filled with resin obtained in Example 3. The above-described resin solution was sprayed from the two flow nozzles at a rate of 18 g/min to carry out resin coating.

Here, as the coating conditions in the fluidized bed coater, the dry air temperature was set at 60° C., and the coating was carried out at a spray pressure of 5 kgf/cm². The speed of the stirring blade provided at a lower part of the fluidized bed coater was 250 rpm.

The temperature was subsequently increased to 220° C., and the mixture was stirred for 2 hours to cure the resin. Ferrite particles in which the resin had been coated and cured were taken out, and particle agglomerates were broken up using a vibrating sieve with 150 M apertures. Using a magnetic separator, non-magnetic matter was removed. Then, again using the magnetic separator, coarse particles were removed, to obtain resin-filled ferrite particles.

### COMPARATIVE EXAMPLES

### Comparative Example 1

The same ferrite core material as in Example 1 was produced. This core material was not subjected to air classification, and was used as the ferrite core material as is.

The resin solution was prepared with the toluene content of the Resin Solution 1 used in Example 1 changed from 500 parts by weight to 1,000 parts by weight. This resin solution and 1,000 parts by weight of ferrite particles were charged into the stirring/mixing vessel. The resultant mixture was stirred at 70° C. under a reduced pressure of 20 kPa, and then filled while the toluene was volatilized off.

The temperature was subsequently increased to 200° C., and the solution was stirred for 2 hours to cure the resin. Ferrite particles in which the resin had been filled and cured were taken out, and particle agglomerates were broken up using a vibrating sieve with 150 M apertures. Using a magnetic separator, non-magnetic matter was removed. Then, again using the magnetic separator, coarse particles were removed, to obtain a resin-filled ferrite carrier.

### Comparative Example 2

A resin-filled carrier was obtained in the same manner as in Example 1, except that Resin Solution 1 and 1,000 parts by weight of the above-described ferrite particles having an average particle size of 26.2 μm, Resin Solution 2 and 1,000 parts by weight of the above-described ferrite particles having an average particle size of 38.8 μm and Resin Solution 3 and 1,000 parts by weight of the above-described ferrite particles having an average particle size of 47.6 μm, were respectively blended together.

### Comparative Example 3

A resin-filled carrier was obtained in the same manner as in Comparative Example 1, except that the toluene content was set at 2,000 parts by weight, and to prolong the time that the toluene was volatilized, the filling of the resin was carried out under a reduced pressure of 2.3 kPA and at a temperature of 40° C.

### Comparative Example 4

A core material was obtained in the same manner as in Example 1, except that the sintering temperature during production of the core material was changed to 1,280° C. The obtained core material was not porous, but was a spherical ferrite core lacking voids continuous from the surface. The volume average particle size of this ferrite core was 34.2 μm.

Next, 100 parts by weight (20 parts by weight in terms of solid content) of the same resin as that used in the filling carried out in Example 1, 3 parts by weight of y-aminopropyltriethoxysilane and 500 parts by weight of toluene were mixed together.

A fluidized bed coater equipped with two flow nozzles was charged with 1,000 parts by weight of the above-described core material. The resin solution was sprayed from the two flow nozzles at a rate of 18 g/min to carry out resin coating.

Here, as the coating conditions in the fluidized bed coater, the dry air temperature was set at 60° C., and the coating was carried out at a spray pressure of 5 kgf/cm². The speed of the stirring blade provided at a lower part of the fluidized bed coater was 250 rpm.

The resin was subsequently heated for 2 hours at 200° C. for curing. Once the heating was finished, particle agglomerates were broken up using a vibrating sieve with 150 M apertures. Using a magnetic separator, non-magnetic matter was removed. Then, again using the magnetic separator, coarse particles were removed, to obtain a resin-coated ferrite carrier.

TABLE 1

| | Resin Filled | | | Volume | | | |
|---|---|---|---|---|---|---|---|
| | Amount * Solid | | | Average | | | |
| | Content | | Correlation | Particle | Apparent | True | Saturated |
| | (parts by | | Equation | Size | Density | Density | Magnetization |
| | weight) | Si/Fe × 100 | Gradient | (μm) | (g/cm³) | (g/cm³) | (Am²/kg) |
| Ex. 1 | 190 | 5.88 | −0.20 | 40.7 | 1.53 | 3.40 | 61 |
| Ex. 2 | 194 | 5.49 | +0.08 | 40.3 | 1.58 | 3.40 | 60 |
| Ex. 3 | 170 | 3.90 | −0.06 | 38.2 | 1.59 | 3.52 | 63 |
| Ex. 4 | 193 | 5.24 | −0.11 | 41.1 | 1.59 | 3.38 | 60 |
| Com. Ex. 1 | 185 | 5.74 | +0.23 | 41.8 | 1.59 | 3.40 | 61 |
| Com. Ex. 2 | 190 | 5.11 | +0.16 | 39.7 | 1.51 | 3.39 | 61 |
| Com. Ex. 3 | 185 | 5.07 | +0.29 | 42.5 | 1.56 | 3.36 | 61 |
| Com. Ex. 4 | 20 (Coated) | 1.11 | +0.35 | 35.7 | 2.17 | 4.79 | 72 |

TABLE 2

| | | Initial Charge | Saturated | Charge Amount | |
|---|---|---|---|---|---|
| | Carrier | Amount | Charge Amount | After Use | Charge Amount |
| | Adhesion | (μC/g) | (μC/g) | (μC/g) | Stability |
| Ex. 1 | E | 25.2 | 26.4 | 26.8 | E |
| Ex. 2 | G | 26.7 | 28.6 | 29.1 | E |
| Ex. 3 | G | 24.6 | 27.4 | 26.8 | G |
| Ex. 4 | E | 20.4 | 24.0 | 23.4 | G |
| Com. Ex. 1 | P | 23.3 | 30.5 | 28.8 | M |
| Com. Ex. 2 | P | 37.2 | 40.8 | 38.1 | M |
| Com. Ex. 3 | M | 35.1 | 39.2 | 37.5 | M |
| Com. Ex. 4 | G | 15.1 | 24.7 | 6.3 | P |

It is clear from the results shown in Table 2 that the resin-filled ferrite carriers obtained in Examples 1 to 4 exhibit extremely good results in the evaluation of carrier adhesion, and that their charge amount also exhibits hardly any change when comparing the initial value and saturated value with after the durability test.

The resin-filled ferrite carriers obtained in Comparative Examples 1 to 3 have a dramatically poorer evaluation of carrier adhesion compared with the resin-filled ferrite carriers obtained in Examples 1 to 4, and were slightly less stable in the stability of their charge amount. Further, while Comparative Example 4, in which no attempt was made to lower specific gravity, showed only a minor deterioration in carrier adhesion compared with the resin-filled ferrite carriers obtained in Examples 1 to 4, the stability of its charge amount was much worse.

### INDUSTRIAL APPLICABILITY

Since the resin-filled ferrite carrier for an electrophotographic developer according to the present invention is a resin-filled ferrite carrier, the resin is present as far as the center vicinity of the interior of the particles, which enables true density to be lighter and a longer life to be achieved. Further, this resin-filled ferrite carrier is stronger than a magnetic powder-dispersed carrier, and yet does not split, deform or melt from heat or shock. In addition, by decreasing the variation among the particles in the amount of resin present in the surface vicinity, and determining the correlation between the average particle size of the resin-filled ferrite carrier and the amount of resin present on the surface to set the gradient of such correlation within a certain range, carrier adhesion can be prevented and good charge amount stability can be obtained. Further, an electrophotographic developer using this resin-filled ferrite carrier can ensure sufficient image density and maintain a high level of image quality for a long period of time.

Accordingly, since image density can be sufficiently ensured and a high level of image quality can be maintained for a long period of time, an electrophotographic developer using this resin-filled ferrite carrier can be widely used especially in the fields of full color machines in which high quality images are demanded, as well as high-speed printers in which the reliability and durability of image sustainability are demanded.

1. A resin-filled ferrite carrier for an electrophotographic developer filled with a silicone resin in voids of a porous ferrite core material which continuously extend from a surface to a core interior, wherein the resin-filled ferrite carrier has an average particle size of 20 to 50 μm, and (Si/Fe)×100 as determined from X-ray fluorescence elemental analysis is 2.0 to 7.0, and the particle size and (Si/Fe)×100 are correlated, and wherein in the correlation relationship between [(Si/Fe)×100] and the particle size, a gradient (a) in a correlation equation thereof is −0.50≦a≦0.15.

2. The resin-filled ferrite carrier for an electrophotographic developer according to claim 1, wherein 6 to 30 parts by weight of the silicone resin are filled per 100 parts by weight of the porous ferrite core material.

3. The resin-filled ferrite carrier for an electrophotographic developer according to claim 1, wherein a composition of the porous ferrite core material comprises at least one selected from the group consisting of Mn, Mg, Li, Ca, Sr, Cu and Zn.

4. The resin-filled ferrite carrier for an electrophotographic developer according to claim 1, having a saturated magnetization of 30 to 80 Am²/kg, a true density of 2.5 to 4.5 g/cm³, an apparent density of 1.0 to 2.2 g/cm³, and 5% or less by volume of particles having a diameter of less than 24 μm.

5. An electrophotographic developer comprising the resin-filled ferrite carrier for an electrophotographic developer according to claim 1 and a toner.

6. An electrophotographic developer comprising the resin-filled ferrite carrier for an electrophotographic developer according to claim 2 and a toner.

7. An electrophotographic developer comprising the resin-filled ferrite carrier for an electrophotographic developer according to claim 3 and a toner.

8. An electrophotographic developer comprising the resin-filled ferrite carrier for an electrophotographic developer according to claim 4 and a toner.
